(19) United States
(12) Patent Application Publication
(10) Pub. No.: US 2018/0089548 A1
(43) Pub. Date: Mar. 29, 2018

(54) Method of Communication Between a Secure Element of a SmartCard and a Microprocessor Performing a Biometric Matching Algorithm

(71) Applicant: Zwipe AS, Oslo (NO)

(72) Inventors: Anthony SIMS, Colorado Springs, CO (US); Jose Ignacio Wintergerst Lavin, Colorado Springs, CO (US)

(21) Appl. No.: 15/713,805

(22) Filed: Sep. 25, 2017

Related U.S. Application Data
(60) Provisional application No. 62/398,753, filed on Sep. 23, 2016.

(51) Int. Cl. G06K 19/07; G06F 21/34; G06F 21/32; G07C 9/00; H04L 9/32

(52) U.S. Cl. CPC G06K 19/0718; G06F 21/34; H04L 9/3231; G06F 21/32; G07C 9/00087; G06K 19/0723

(57) ABSTRACT

The manufacturers of a secure element define a standard communication protocol for use when communicating with the secure element. However, messages sent in accordance with this protocol do not use all of the bytes received. This disclosure provides additional functions that are achieved by loading different message segments to these existing, but unused bytes.

### TECHNICAL FIELD

This disclosure relates to a smartcard, either contact, contactless or both (combo), which is capable of performing biometric authentication of a bearer of the smartcard using an on-board biometric sensor. The card may be powered by a battery, power harvested from the energy radiated by the payment terminal or power supplied through the contact pad. The smartcard is preferably a payment card.

### BACKGROUND OF THE INVENTION

The output from the smartcard, e.g., to authorize a payment transaction, is facilitated by contacting a contact pad as for a contact smartcard or by an NFC signal as for contactless smartcards. There are also combo cards which may be accessed by either means. The management of the security and the transaction is handled by a so called “secure element” which is basically a microprocessor with flexible transaction capability. This microprocessor is usually attached to several contact pads and is loaded with proprietary software which is zealously protected by the issuing banks. Secure elements are manufactured and designed by companies such as Multos, G&D, Gemalto and Oberthur to name just a few.

Another microprocessor running firmware proprietary to the biometric application, referred to herein as the biometric authentication module, is capable of switching on the secure element once a successful biometric match has been confirmed. In previous embodiments, security was handled by a solid state switch for enabling or disabling power and antenna access to the secure element. This method has weak security because a skillful hacker could cut through the surface of the card, locate the necessary conductors, and make the appropriate connections to force the card into a constant enabled state.

A proposed fix for this weakness is to address the secure element in a digital manner using conventional Public Key Infrastructure (“PKI”). PM implementation starts by loading similar keys onto the secure element and the biometric authentication module during manufacture. These keys are used to encode the communications (encrypt) between the secure element and biometric authentication module. This solves some but not all of the problems.

The present disclosure seeks to improve communication between the secure element and the biometric authentication module.

### SUMMARY OF THE INVENTION

The manufacturers of a secure element define a standard communication protocol for use when communicating with the secure element. However, messages sent in accordance with this protocol do not use all of the bytes received. This disclosure provides additional functions that are achieved by loading different message segments to these existing, but unused bytes.

These and other features and improvements of the present application and the resultant patent will become apparent to one of ordinary skill in the art upon review of the following detailed description when taken in conjunction with the shown drawings and the appended claims.

### BRIEF DESCRIPTION OF THE DRAWINGS

A preferred embodiment will now be described in greater detail, by way of example only and with reference to the accompanying drawings, in which:

FIG. 1 illustrates the flow of data between the biometric authentication module and the secure element;

FIG. 2 illustrates an 8-byte command message from the secure element to the biometric authentication module;

FIG. 3 illustrates an 8-byte message from the biometric authentication module to the secure element including a biometric result;

FIG. 4 illustrates an 8-byte response message from the biometric authentication module to the secure element including confirmation of an action; and

FIG. 5 illustrates an 8-byte response message from the biometric authentication module to the secure element including that an illegal command has been received.

### DETAILED DESCRIPTION

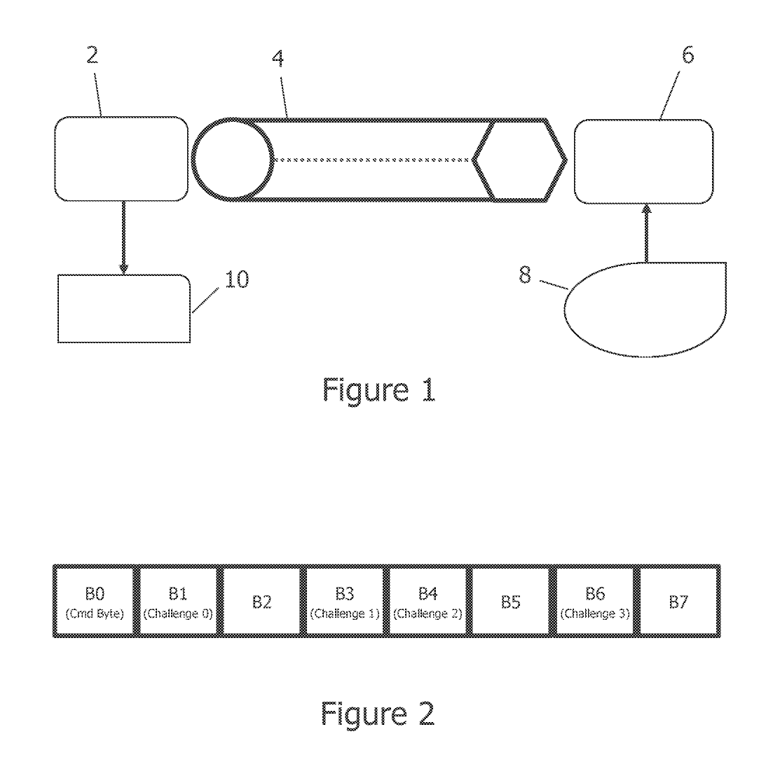

FIG. 1 illustrates a secure element 2 communicating over a communications channel 4 with a biometric authentication module 6. The secure element 2, the communications channel 4 and the biometric authentication module 6 are embedded within a smartcard. The biometric authentication module 6 is configured to receive and process fingerprint data 8 from a finger presented to a fingerprint sensor on the smartcard. The secure element 2 is configured to send authorization data 10 to a terminal external of the smartcard to authorize a transaction following authentication of the fingerprint data 8 by the biometric authentication module.

The manufacturer of the secure element 2 defines a standard communication protocol for use when communicating with the secure element 2. However, messages sent in accordance with this protocol do not use all of the bytes received. That is to say, in accordance with the protocol, certain bytes of data that are sent are simply discarded when processing the messages. For example, in the illustrated embodiment, the messages are 8 bytes long but only up to 6 of the bytes have a defined usage in the communications protocol. It will be appreciated that the invention is not restricted to 8-byte messages.

The Figures show how this simple interface may be enhanced by the addition of valuable but previously unused functionality. This disclosure provides additional functions which are achieved by loading different message segments to these existing, but unused bytes.

FIG. 1 illustrates an exemplary command message sent from the secure element 2 to the biometric authentication module 6. Standard secure element protocol requires the command to occupy byte B0 of the message followed by four challenge bytes at bytes B1, B3, B4 and B6 of the message. In accordance with the disclosure, the three remaining bytes at B2, B5 and B7 may be used to provide additional functionality.

These bytes may be used, for example, to verify the origin of the message or the time when the message was transmitted, or they may contain random data to prevent an intercepted message from being copied and re-sent multiple times. The bytes may also be used to provide error checking functionality, such a cyclic redundancy check (CRC) as illustrated below.

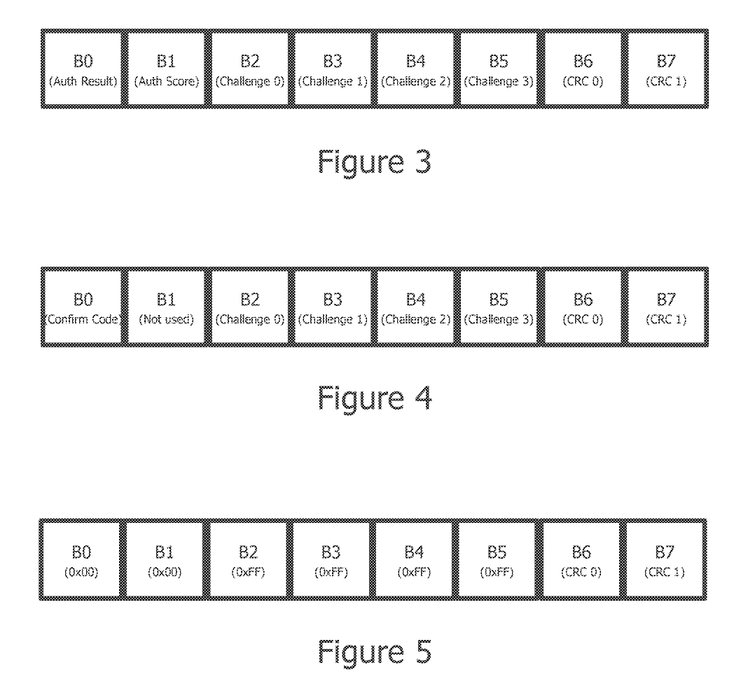

FIG. 3 illustrates an exemplary message from the biometric authentication module 6 to the secure element 2 containing the results of a fingerprint authentication. Byte B0 contains the result of the fingerprint authentication, byte B1 contains a score indicating the correlation of the match, and bytes B2, B3, B4 and B5 contain challenge bytes. In accordance with the disclosure, two CRC bytes are included at bytes B6 and B7 of the message, which are not used in accordance with the standard secure element protocol.

FIG. 4 illustrates an exemplary message from the biometric authentication module 6 to the secure element 2 confirming that an action has been completed, for example erasure of biometric data. In accordance with the disclosure, byte B0 contains the confirmation and bytes B6 and B7 contain CRC bits, which are not used in accordance with the standard secure element protocol. This message format is not used by the standard secure element communication protocol.

FIG. 5 illustrates an exemplary message from the biometric authentication module 6 to the secure element 2 responsive to an illegal command, e.g. because of a failed challenge byte. Bytes B0 and B1 that are checked by the standard communication protocol are set to null values and the four challenge bytes B2, B3, B4 and B5 are set to fixed values indicating an error. Bytes B6 and B7 again contain CRC bits.

Further exemplary functions that may be loaded into the previously unused bytes include:

(1) Biometric Erasure and Confirmation. It may be desirable in the case of a card being used fraudulently to actually erase the contents of the smartcard memory removing the biometric template residing there. A confirmation message as shown in FIG. 4 may also be sent back to the Secure Element so it can relay the message that the erasure has been accomplished to the host terminal. Transmission of the erasure and confirmation message is regarded as a “doomsday” response, by the biometric authentication module 6, indicating the card is rendered useless.

(2) Illegal Command. In the case that the secure element sends a Challenge message to the biometric authentication module. If an illegal message is embedded in the data, the biometric authentication module may respond with a certain coded message embedded in the non-protocol bytes indicating that the Challenge message was corrupt.

By using these currently unused byes, the overall quantity of data transmitted is not increased, which is important on a smartcard where power consumption must be carefully regulated. Furthermore, the use of embedded challenge and response messages allows for continuous monitoring of the integrity of the communication link.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A method of communication between a secure element of a smartcard and a biometric authentication module of the smartcard, the method comprising:
generating a primary message for transmission between the secure element and the biometric authentication module, wherein the secure message complies with a communications protocol, and wherein the communications protocol defines one or more regions of data within the message that are not to be processed in accordance with the communications protocol; and
creating a modified message by embedding a secondary message for transmission between the secure element and the biometric authentication module into the one or more regions of data in the primary message that are not to be processed in accordance with the communications protocol; and
transmitting the modified message from one of the secure element and the biometric authentication module to the other of the secure element and the biometric authentication module.

2. A method of communication between a secure element of a smartcard and a biometric authentication module of the smartcard, the method comprising:
receiving a message from one of the secure element and the biometric authentication module;
processing the received message in accordance with a communications protocol, wherein the communications protocol defines one or more regions of data within the message that are not to be processed in accordance with the communications protocol; and
processing a secondary message that is embedded in the one or more regions of data in the primary message that are not processed in accordance with the communications protocol.

3. A smartcard comprising a secure element and a biometric authentication module, wherein the smartcard is configured to allow communication between the secure element and the biometric authentication module, at least one of the secure element and the biometric authentication module being configured to operate in accordance with the method of claim 1.

4. A smartcard comprising a secure element and a biometric authentication module, wherein the smartcard is configured to allow communication between the secure element and the biometric authentication module, at least one of the secure element and the biometric authentication module being configured to operate in accordance with the method of claim 2.

5. A smartcard comprising a secure element and a biometric authentication module, wherein the smartcard is configured to allow communication between the secure element and the biometric authentication module, the secure element and the biometric authentication module being configured to communication by a method comprising:
generating a primary message for transmission between the secure element and the biometric authentication module, wherein the secure message complies with a communications protocol, and wherein the communications protocol defines one or more regions of data within the message that are not to be processed in accordance with the communications protocol; and
creating a modified message by embedding a secondary message for transmission between the secure element and the biometric authentication module into the one or more regions of data in the primary message that are not to be processed in accordance with the communications protocol; and
transmitting the modified message from one of the secure element and the biometric authentication module;
receiving a message at the other of the secure element and the biometric authentication module;
processing the received message in accordance with the communications protocol; and
processing the secondary message that is embedded in the one or more regions of data in the primary message that are not processed in accordance with the communications protocol.
